(19) United States
(12) Patent Application Publication
(10) Pub. No.: US 2020/0203846 A1
(43) Pub. Date: Jun. 25, 2020

(54) REMOTE ELECTRIC TILTABLE DIFFUSING FOCUSING PASSIVE REFLECTOR

(71) Applicant: Nokia Solutions and Networks OY, Espoo (FI)

(72) Inventors: John HARRIS, Whitefish Bay, WI (US); Roy YANG, Buffalo Grove, IL (US)

(21) Appl. No.: 16/642,843

(22) PCT Filed: Sep. 1, 2017
(86) PCT No.: PCT/US2017/049975

§ 371 Date: Feb. 27, 2020

(51) Int. Cl. H01Q 15/14; H04B 7/145; H04B 7/06; H01Q 15/16

(52) U.S. Cl. CPC H01Q 15/147; H01Q 15/16; H04B 7/0617; H04B 7/145

(57) ABSTRACT

Small wave communications between a base station and user equipment are facilitated by transmitting a movement request to a movable element to change a position when the movable element is in a beam path for an RF communications beam of more than 6 GHz between a first user equipment and a base station. The movable element may be a reflector that reflects the small wave to the user equipment, or an object whose movement improves a communication path.

### CROSS-REFERENCE TO RELATED APPLICATIONS

This application is a U.S. National Phase of International Application No. PCT/US2017/049975 filed on Sep. 1, 2017.

### BACKGROUND

Explosive growth of mobile traffic has resulted in spectrum shortage in RF frequencies below 6 GHz. Millimeter wave spectrum, with a substantial amount of unoccupied bandwidth, is an attractive avenue for expanding mobile spectrum. Millimeter wave communications has emerged as an important part of 5G mobile networks to provide high-capacity, high-speed and low latency services to end users.

In July of 2016, the Federal Communications Commission (FCC) of the United States opened up 10.85 GHz of millimeter wave (mm-wave) spectrum for 5G communications. The newly freed spectrum includes 3.85 GHz of licensed spectrum from 27.5-28.35 GHz and 37-40 GHz, as well as 7 GHz of unlicensed spectrum from 64-71 GHz.

Research has shown that adequate outdoor coverage for up to about 220 meters is possible for mm-wave channels. Such small cell size favors the use of low power microcell or picocell base stations with highly directional narrow beams. A suitable narrow beam can be generated through beamforming devices such as a multi-antenna-element phased array.

Signals in the mm-wave area of the RF spectrum suffer from high propagation loss and are highly susceptible to blockage from buildings, humans, foliage and even rain drops. For example, a single-tree (sparse foliage) scenario penetration loss can be between 0 and 6 dB while a double-tree (dense foliage) scenario the loss can be 8 dB to 28 dB. Building materials such as tinted glass can absorb up to 40 dB at certain wavelengths, potentially preventing effective propagation through structures. As a result, the ideal millimeter wave communication scenario is line of sight (LOS).

There are many challenges associated with establishing LOS conditions for delivering broadband service to structures. Mounting locations for base stations are frequently on the tops of existing structures, such as buildings and public utility elements. LOS vectors from such locations frequently pass through foliage and intervening structures which would block mm-wave signals. Many structures do not have a window that is in the LOS to a base station, and when a LOS between a mm-wave base station and a window of a structure is present, it is not always feasible to mount customer premises equipment (CPE) in the specific LOS window.

Even when a LOS condition between a base station and a window of a structure is present, that situation can change to a Non-line of sight (NLOS) condition over time. For example, foliate can grow into the LOS path over time, large vehicles could park in or pass through the LOS path, structures could be erected or placed in the LOS path, etc. Humans passing through the path can effectively block mm-wave signals as well.

One possible approach to establishing LOS conditions to deliver mm-wave broadband service is to simply install additional base stations. However, it is not always feasible to install base stations at LOS locations due, for example, to a lack of infrastructure at such locations. In addition, there are substantial operating and capital expenses associated with base stations, so deploying them in quantities sufficient to establish LOS conditions with many customers is not economically feasible. In summary, there substantial challenges associated with delivering high quality, un-interrupted service through high frequency communications.

### FIELD OF TECHNOLOGY

Embodiments of the present disclosure are directed to a system and method for a wireless telecommunications network. In particular, embodiments are directed to transmitting a movement request message for one or more movable element to change a physical configuration to facilitate wireless communications between a base station and user equipment (UE).

### BRIEF SUMMARY

Embodiments of the present disclosure relate to scenarios where, for example, there is a 1st UE with a need to communicate efficiently with cellular AP (e.g. using high-frequency/5G cellular technology), where that connection can be impacted by the movement of an intervening 3rd connected device, where that third device has the ability to move a physical element that is not part of the cellular infrastructure. The connection may be made according to one or more software or standard developed for internet communication, Internet of Things (IoT) communication, wireless communication, and machine communication. The communication between the UE and the AP may be in part of the RF spectrum that is reflected by the intervening connected device. In one example, the intervening device is a reflector that reflects a narrow communication beam to the UE, while in another example, the intervening device is a movable object that would otherwise inhibit communication.

According to an embodiment of the present disclosure, a process for a wireless communications network includes transmitting a movement request to a movable element to change a position, wherein the movable element is in a beam path for an RF communications beam of more than 6 GHz between a first user equipment (UE) and a base station. The RF communications beam may be transmitted from the base station to the first UE, and the movable element may be a reflector that reflects the RF communications beam from the base station to the first UE.

Before transmitting the request, the base station may transmit RF beams in a plurality of directions to identify a beam direction that is successfully received by the reflector. The plurality of directions may be a set of directions that are determined using a location of the base station and a location of the reflector. The reflector may have a convex outer surface comprising a plurality of flat elements arranged in a convex shape.

In an embodiment, in response to the request to change position, the reflector moves from a first position from which it reflects the RF communications beam to the first UE to a second position from which it reflects the RF communications beam to a second UE. The first UE may be customer premises equipment (CPE) that is installed at a static location of a building structure.

A movement request to a movable element to change a position may be triggered by an installation routine that is performed when the first UE is installed at the static location.

The movable element may be an Internet-of-Things (IOT) enabled device that blocks a beam path for the RF communications beam, where the movable element moves to unblock the beam path in response to the movement request. In another embodiment, the movable element is a reflector with a convex outer surface that has established a connection to receive the RF communications beam from the base station, wherein the base station is a small cell base station that provides broadband communications over at least one RF communication channel of 25 GHz to 100 GHz, and wherein, in response to the movement request, the reflector moves from a first position to a second position in order to reflect the RF communications beam to the first UE.

### BRIEF DESCRIPTION OF THE DRAWINGS

FIG. 1 illustrates a wireless communications system.

FIG. 2 illustrates a network computing entity of a communications system.

FIG. 3 illustrates wireless communication elements arranged according to an embodiment.

FIG. 4 illustrates an embodiment of a movable element.

FIG. 5 illustrates movable elements adapted to enhance wireless communication.

FIG. 6 illustrates an embodiment of a process for controlling movable elements to provide small wave communications to a subscriber.

### DETAILED DESCRIPTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

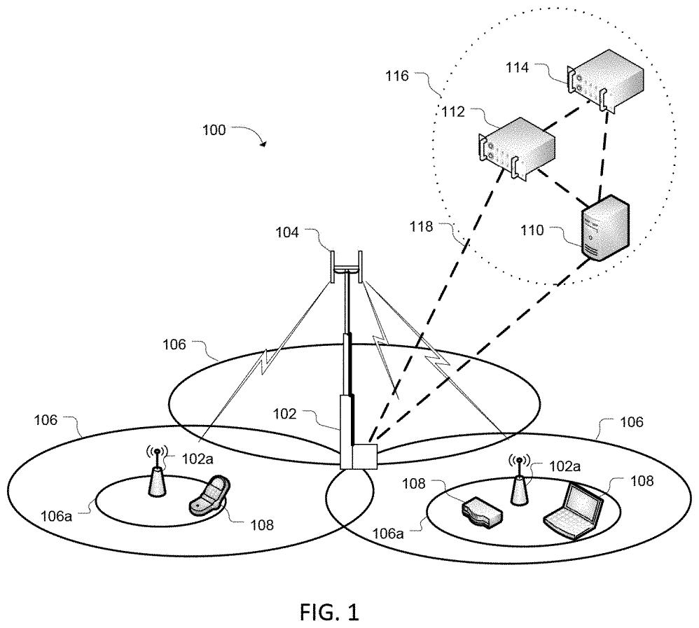

FIG. 1 illustrates a communications network 100 according to an embodiment of this disclosure. Network 100 includes a plurality of base stations 102, each of which are equipped with one or more antennas 104. Each of the antennas 104 may provide wireless communication for user equipment (UE) 108 in one or more cells 106. Base stations 102 have antennas 104 that are receive antennas which may be referred to as receivers, and transmit antennas, which may be referred to as transmitters.

As used herein, the term “base station” refers to a wireless communications station provided in a location and serves as a hub of a wireless network. For example, in LTE, a base station 102 may be an eNodeB. The base stations may provide service for macrocells, microcells, picocells, or femtocells.

FIG. 1 shows base station 102 that provides service to small cells 106a that are within a coverage area of macro cells 106. In actual cellular deployments, a plurality of base stations 102a may be located within a cell 106 of a macro cell base station 102. As a result, coverage of one macro-cell 106 may overlap with a plurality of small cells 106a.

The one or more UE 108 may include cell phone devices, mobile hotspots, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, mobile hotspots, handheld gaming units, electronic book devices, personal music players, video recorders, etc.), having wireless communications capabilities employing any common wireless data communications technology, including, but not limited to: GSM, UMTS, 3GPP LTE, LTE Advanced, etc.

In embodiments of the present disclosure, a UE 108 may be customer premises equipment (CPE) that are installed at a customer's premises. Examples of CPE include wireless routers, modems, set-top boxes, relays, and other devices that can receive wireless communications from a base station. In particular, the CPE may receive high frequency narrow beam transmissions from a nearby small cell 106a. The CPE may be owned and controlled by a customer or a service provider.

The communications network 100 includes an operations and management (O&M) portion 116 that can facilitate distributed network communications between backhaul equipment or network controller devices 110, 112 and 114 and the one or more base station 102. As would be understood by those skilled in the art, in most digital communications networks, the O&M portion 116 of the network may include intermediate links 118 between a backbone of the network which are generally wire line, and sub networks or base stations located at the periphery of the network. For example, cellular mobile devices (e.g., UE 108) communicating with one or more base station 102 may constitute a local sub network. The O&M system may include network elements that form an Operations Support System (OSS) for the network.

In an embodiment, communication links of the communications network 100 may employ any of the following common communications technologies: optical fiber, coaxial cable, twisted pair cable, Ethernet cable, and power-line cable, along with any wireless communication technology known in the art. In context with various embodiments, wireless communications coverage associated with various data communication technologies (e.g., base station 102) typically vary between different service provider networks based on the type of network and the system infrastructure deployed within a particular region of a network (e.g., differences between GSM, UMTS, LTE, and LTE Advanced, based networks and the technologies deployed in each network type).

Any of the network controller devices 110, 112 and 114 may be a dedicated Network Resource Controller (NRC) that is provided separately from the base stations or provided at the base station. Any of the network controller devices 110, 112 and 114 may be a non-dedicated device that provides NRC functionality. In an embodiment, an NRC is a Self-Organizing Network (SON) server. Any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a RNC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system. Any of the network controller devices 110, 112 and 114 or any of the base stations 102 may employ any number of common server, desktop, laptop, and personal computing devices.

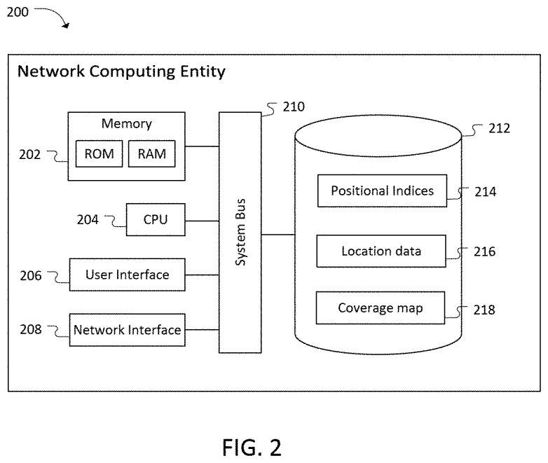

FIG. 2 illustrates a block diagram of a computing entity 200 that may be representative of any of the network controller devices 110, 112 and 114. Accordingly, computing entity 200 may be representative of a Network Management Server (NMS), an Element Management Server (EMS), a Mobility Management Entity (MME), a SON server, a self-operation server, etc. The computing entity 200 has one or more processor devices including a CPU 204. Although a single CPU is shown, the computing entity 200 may include a plurality of CPUs, each of which may include a plurality of processing cores operative to perform processes described in this disclosure.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, similarity measure 214, mapping data 216, and event data 218.

The computing entity 200 may also include a user interface 206 that allows an administrator to interact with the NRC's software and hardware resources and to display the performance and operation of the system 100. In addition, the computing entity 200 may include a network interface 208 for communicating with other components in the networked computer system, and a system bus 210 that facilitates data communications between the hardware resources of the computing entity 200.

In addition to the network controller devices 110, 112 and 114, the computing entity 200 may be used to implement other types of computer devices, such as an antenna controller, an RF planning engine, a core network element, a database system, or the like. Based on the functionality provided by computing entity 200, the storage device of such a computer serves as a repository for software and database thereto. In embodiments of the present disclosure, the computing entity 200 represents computing entities that perform processes described herein. In various embodiments, these entities may be combined in a single hardware enclosure, or distributed among multiple hardware enclosures at various locations.

Embodiments of the present disclosure relate to delivering one or more relatively high-frequency, short wavelength RF channel that does not have a line-of-sight (LOS) path to a first UE that receives the RF channel. Some of this spectrum is present in what is commonly referred to as a millimeter-wave portion of the spectrum. The term “millimeter-wave” is a general term that is understood to occupy different portions of spectrum by different persons of skill in the art. Accordingly, the present disclosure uses the term “millimeter-wave,” and the more general term “small wave,” to refer to portions of the RF spectrum that are above 6 GHz that are used for wireless communication. A characteristic of small waves is that they are subject to higher levels of attenuation than portions of spectrum historically allocated for wireless communications, e.g. 800 MHz-5 GHz.

Portions of spectrum of 27.5-28.35 GHz, 37-40 GHz, and 64-71 GHz have been recently released by the FCC in the United States, all of which is within the scope of “small waves” as used by this disclosure. However, the scope of this disclosure is not limited to these specific frequencies- other portions of spectrum between 6 GHz and 27.5 GHz, and above 71 GHz, are also within the scope of this disclosure.

Embodiments of the present disclosure may include leveraging existing remote movable devices, in addition to smartly enabled movable devices that are installed for the purpose of reflecting small wave beams. These embodiments can enable broadband wireless communications to be more pervasive.

The number of internet-enabled devices is expected to continue to grow in the future, where many such devices will not only have limited Internet connectivity but they will have the ability to interact in various ways with the physical world, e.g. involving physical movement. These devices may be passive objects, e.g. doors, garage doors, windows, canopies, mobile roofs and tilting solar panels, and include other even smarter objects such as remote-control robotics and connected cars. Various embodiments may employ any such device to improve conditions related to delivery of a small wave communications channel.

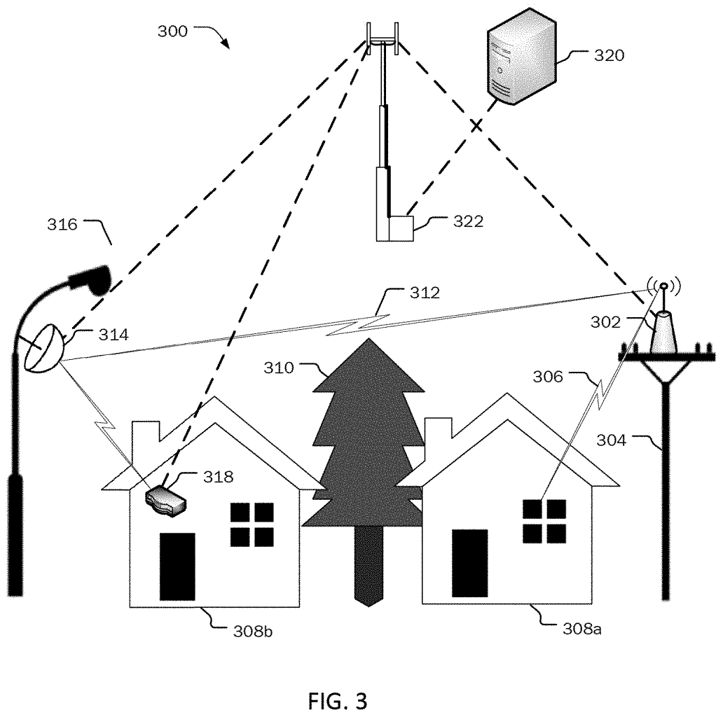

FIG. 3 shows an example scenario of using a remote-tilt passive reflector to deliver small wave communications to a first UE. In FIG. 3, base station 302 is a small cell base station that is mounted on a utility pole 304. The base station 302 has a LOS path to deliver small wave communications beam 306 to a first household 308a. However, a tree 310 and the first household 308a prevent the base station 302 from having a LOS path to a second household 308b. The LOS path may provide small wave communications from the base station 302 to the first UE, as well as from the first UE to the base station.

Accordingly, the base station 302 transmits a second small wave beam 312 to a movable element 314 mounted to a light pole 316, which reflects the beam directly into the second household 308b where it is received by a first UE 318 in a LOS path from the reflector. Any of the base station 302, movable element 314, first UE 318, server computer 320 and macro-cell base station may be included in a small wave communications system 300.

In an embodiment, one or more of the base station 302, movable element 314, and first UE 318 communicates independently with a central server computer 320 that coordinates communications between those devices to facilitate small wave wireless communications between the base station 302 and the first UE 318. The independent communication may be cellular communication with a macro-cell base station 322. In other embodiments, the communication may be over other channels, and may relay between devices. For example, the movable element 314 may communicate directly with the first UE 318 and/or the base station 302 using Wi-Fi or Bluetooth communications. In addition, the base station 302 may relay communications from the movable element 314 to the server computer 320.

This direct communication can facilitate determining the impact of various configurations of the movable element 314 on the small wave communication channel. In addition, such communication can facilitate messaging from the base station 302 to the movable element 314 to change its position. In conjunction with communications from the first UE 318, such communication can determine the effects of positional changes in order to optimize the movable element's position for delivering small wave communications to the first UE 318.

One or more of the electronic devices shown in FIG. 3 may be connected or controlled through an Internet of Things (IOT) application or protocol. For example, the server computer 320 may be an IOT controller, and may be a cloud computing device that manages communication between a plurality of IOT devices. In addition, the first UE 318, the movable element 314, and the base stations 302 and 322 may be configured to communicate with an IOT controller through an IOT application. In some embodiments, an IOT controller may be implemented in one or more of the macro-cell base station 322, the small cell base station 302, and the first UE 318 to manage communications in system 300.

Although FIG. 3 only shows a single reflector 314 reflecting beam 312 to first UE 318, in other embodiments, multiple reflectors may be used to direct a small wave beam from the base station 302 to the first UE 318. In some embodiments, one or more of the reflectors may have additional functionality. For example, a reflector 314 can be CPE that receives and processes a portion of the small wave beam, while reflecting another portion of the small wave beam to one or more downstream device.

The first UE 318 may be installed at a static location within household 308b, or on a location outside of the household 308b. In some situations, it may not be feasible to mount the first UE close to window or other radio-transparent of a building such that it is practical to receive small wave beam 312 at an indoor location. In such an embodiment, the first UE 318 may be CPE that is installed at an exterior surface of a building structure, and the first UE may deliver broadband signals through a wire that penetrates into the building structure. In both of these embodiments (interior and exterior mounting), the first UE is installed at a static location of a building structure.

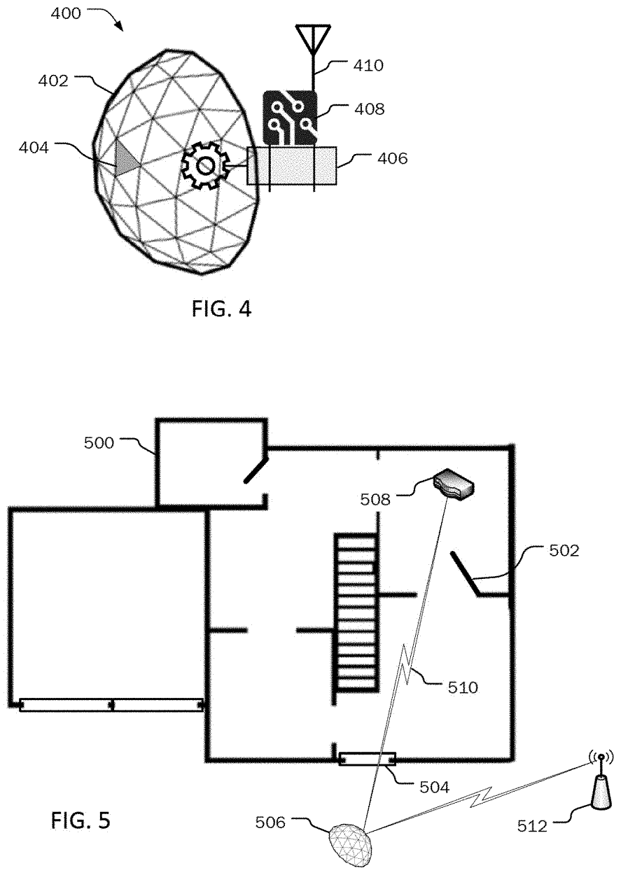

FIG. 4 shows an example of a movable element 400 that is a reflector such as the reflector 314 shown in FIG. 3. The movable element 400 includes a reflective surface 402 that is configured to reflect small wave RF beams. The reflective surface 402 may include a metal material, and it may have a relatively smooth surface to avoid scattering a small wave beam. The surface may have a surface roughness that is sufficient to provide even predictable reflections of high frequency waves, e.g. have an RA value of 0.1 mm, 0.01 mm, or less.

The reflective surface 402 shown in FIG. 4 has a geodesic shape comprising a plurality of flat triangular elements that are arranged to create a convex reflective surface. In other embodiments, the surface may have a substantially smooth shape that is free of abrupt transitions across a reflecting portion of the surface, e.g. a hemispherical shape. In other embodiments, the reflective surface has a concave surface to focus a beam, or has a combination of convex and concave surfaces to either spread or focus a small wave beam depending on the wireless environment. A convex surface may generate reflections over a wider range of adjacent angles, instead of reflecting only at a single angle, potentially simplifying or accelerating the process of identifying a position for the third device which will enable LOS communication between a base station and a first UE.

Establishing a connection to a small wave beam may include a scanning phase during which the movable element utilizes a more convex reflective configuration so that a small wave beam from a base station is dispersed over a wider area, to enable detecting that the reflector position is nearly, but not necessarily perfectly, positioned to deliver broadband service to the first UE. In some embodiments, a wider beamwidth is used to establish a connection between small cell base station, the movable element and the first UE than the beamwidth that is ultimately used for broadband communications. In some embodiments, a lower frequency beam, e.g. a 5 GHz beam, is used for coarse targeting operations when establishing a connection between the base station, the movable element and the first UE.

The reflective surface 402 may include one or more radio-transparent area 404. The radio-transparent area 404 allows the movable element 400 to determine that a small wave is directed to its surface. The radio transparent area 404 may be a grating or one or more hole in the reflective surface 402 that allows RF waves to pass through the reflective surface 402 into a detector included in the movable element 400. The reflective surface 402 may be as small as a few centimeters wide, or as large as several tens of centimeters.

After a small wave connection between the base station and a movable element 400 that is a reflector is established, the reflector may continue to monitor for the presence of the small wave beam to ensure that the connection is being successfully maintained. This information can be used, for example, to troubleshoot the system when communications are lost.

The movable element 400 includes one or more motor 406 that allows the element to change its orientation. The movable element 400 may be able to move and rotate in multiple axes, including tilting and panning in orthogonal planes, rotating, and moving upwards, downwards, and from side to side. The movable element 400 may also have a power system that includes a solar panel and a battery for autonomous power. In other embodiments, such as when the movable element 400 is attached to a utility pole, it can receive power from a power line.

The movable element 400 includes circuitry 408 that may include a memory and a processor. The memory may store information including an index of positions and channel conditions experienced by the movable element 400 and one or more UE at each position. The movable element 400 can use such an index to rapidly change between various positions to, for example, switch service between two UEs. In addition, the movable element 400 may include an antenna 410 that facilitates wireless communications between various elements of a remote tilting system.

Although a movable element 400 that is a reflector is an active device that may be capable of transmitting and receiving wireless communications through antenna 410, the reflector is different from a conventional relay device. While a relay device is fundamentally a transceiver that relies on an antenna to “forward,” or relay communications from one device to another device, a reflector according to embodiments of the present passively reflects small wave beams between a source and destination to facilitate wireless communication. Accordingly, a reflector of the present disclosure is different from a conventional wireless relay device.

FIG. 5 shows an embodiment that includes a plurality of different movable elements. A structure 500 is equipped with two movable elements—a door 502, and a window covering 504. Both of those movable elements communicate through an IOT application, so both elements can be remotely controlled.

As seen in FIG. 5, the door 502 and window covering 504 are disposed in a communication path between a reflector 506 and a first UE 508. The reflector 506 reflects a small wave beam 510 from a base station 512 to the first UE 508 to provide broadband communications. In the embodiment shown in FIG. 5, the positions of all three movable elements—the door 502, the window covering 504, and the reflector 506—affect the ability of the first UE to receive the small wave signals 510. Accordingly, the positions of all three movable elements may be controlled by embodiments of the present application.

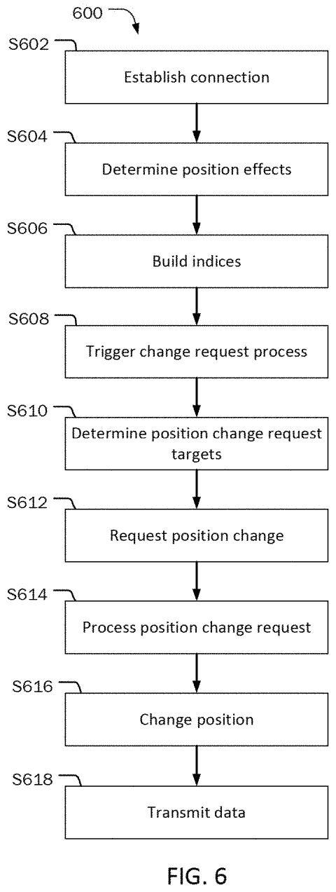

FIG. 6 illustrates a process for controlling movable elements to provide small wave communications to a subscriber. One or more connection between the base station 512 and various network equipment may be established at S602. In an embodiment, at least a portion of the connections are established when network equipment such as the first UE 508, a movable element, and a small cell base station 512 that can deliver a small wave beam is initially installed. The connection may be a general wireless link that allows the network equipment to communicate without a small wave beam, and that wireless link may be used to establish a small wave connection between the base station and the first UE.

The impact of various positions of movable elements (e.g., 504, 506 or 508) on communications between the first UE 508 and the base station 512 may be determined at S604. Determining the impact of the movable element's position on communications between the first UE 508 and the base station 512 may include storing signal strength values of small wave signals received at the first UE along with the positions of the movable element associated with each signal strength value. Using this information, a system may be able to determine a scale, or level of sensitivity, associated with an amount of physical change. The sensitivity information could then be used to calibrate movements of the movable element to optimize motion of the movable element by progressively refining movements to maximize reception at the first UE 508.

In some embodiments, determining the impact of the movable element's position includes detecting the spatial location of the communication devices, or detecting radio signal strength measurements from one or more of the devices, e.g. monitoring changes before and after each physical configuration change. Movements of the movable elements to determine the effects of various positions may be performed at a time of low network activity.

One or more component of a small wave communications system may create an index at S604. In an embodiment, the base station 512 determines a beam index that enables it to transmit in the direction of the reflector element 506, e.g. by using existing mechanisms while communicating line of sight from the base station to the reflector.

Embodiments of the present disclosure may include a network database of positional indexes for each of a plurality of devices including IOT devices, which have the ability to impact the physical environment, creating a plurality of positional configurations or indexes. For example, a door 502 or a window shade 504 or other smart device may be able to not only detect but also control the movement of different items in the physical world. This might include controlling the position of a window covering or a helper robot, or detecting the position of an interior door, a garage door, or a vehicle. For each such element, the element can take on a number of different physical configurations, which may impact communication among other devices, such as impacting a cell phone communicating with a cellular base station.

Each movable element may specify attributes of its physical configuration in terms of a three-dimensional model anchored at a particular (GPS) location. The movable elements may specify other attributes such an amount of RF signal attenuation, constraints on their ability to move, material composition, etc.

In some embodiments, movable elements may communicate a positional index. The positional index might be an opaque number or signature or hash corresponding to the current position of the device. In addition to the positional index, movable elements may provide a current location, such as latitude and longitude coordinates established by a GPS.

In addition, the device may communicate attributes that further contribute to its positional index, including attributes such as a current color or image that it is displaying, a sound it is generating, an optical permissiveness at different wavelengths, and an RF permissiveness at different wavelengths. This positional index may additionally indicate current or future time intervals that are expected to correspond to those positional indices.

In another example, a movable element may indicate the likelihood of particular positional indexes as a function of times of day and days of the week, e.g. a particular door or window covering is more likely to be open during certain times and days. The positional index may also include a positional index trajectory, which may detail information on how quickly a movable device can respond to a movement request. This may relate to how quickly a door can open or close, or how quickly a movable reflector can change its position.

In an embodiment, positional indices are built by scanning positions of movable elements. Scanning positions of an element may include scanning across a set of positions where that set of positions are determined based upon the approximate location of the base station 512, one or more movable element, and the UE 508. Location inputs for those devices can be used to estimate what positions of the third device are most likely to yield a direct path of reflection between the base station 512 and the UE 508, with one or more intervening movable element.

In an embodiment, an initial process of scanning to find a connection may be for identifying a starting point for subsequent refined scanning steps. In such an embodiment, a movable element scans more slowly through a set of smaller position adjustments to determine if a slightly different position will yield an even better connection between the first UE 508 and the base station 512.

In an embodiment, subsequent to the initial scanning phase, the movable element scans positions utilizing a more concave reflective configuration relative to the initial scanning, so that a small wave is focused on an incrementally smaller area, to determine if that will yield an even better connection between the first UE 508 and the base station 512.

In an embodiment, a movable element switches between a first position that enables small wave communication for the first UE and a second position that enables communication for a second UE, wherein switching between these two positions is requested based upon at least one aspect of communication for the first and second UE. For example, the movable element may switch from one position to another depending upon which UE is currently performing a transfer, or based upon which position will save the greatest amount of wireless resources, thereby avoiding the use of longer wavelength communications. In another embodiment, the movable element switches positions when one of the UEs receives an obstruction that prevents it from successfully receiving the small wave beam. Another example of switching between UEs may occur when one of the UEs requests a priority transmission, such as an emergency call (e.g. a 911 call), a public safety call, etc.

One or more event that triggers sending a movement request message to a movable element may occur at S608. A movement request may be triggered by a number of different situations. When the movable element is a reflector, a movement request to change the orientation of the reflector may be made in conjunction with an installation routine when, for example, the first UE 508 is a newly installed wireless router. Another trigger for transmitting a motion request may be a change in the wireless environment around the first UE 508, such as an outage, communication failures with other wireless equipment, reduced coverage, or increased congestion in the area. In other words, a movement request to improve wireless channel access to the first UE 508 may be made when its ability to communicate over other channels is reduced, or expected to be reduced.

Movement requests to movable elements may be triggered when the first UE 508 has not communicated with other network elements for a predetermined amount of time, which may indicate failure of other communication channels. Another trigger for the movement request is when a battery life of the first UE 508 is less than a threshold value, where improving wireless channels to the first UE can reduce its energy consumption. Another trigger is performing a location determination, where changing the configuration of the movable element may improve the location accuracy. Another trigger is when a relatively large communication is anticipated- for example, when a file transfer over a predetermine threshold is initiated, or some other high bandwidth application is being performed or is requested to be performed. Still another example trigger is a change in weather conditions which affects wireless coverage.

In some embodiments, a user of the first UE 508 can set trigger information for initiating a motion request, such as identifying certain applications (e.g. telephony service) or file sizes that will trigger the request, or identifying other communication situations that would trigger a movement request. For example, a policy can be established where when a user attempts to stream video from a basement, a door to the basement will automatically open, allowing better wireless coverage in the basement area.

Although several specific examples of trigger conditions for a movement request are listed above, embodiments are not limited to these specific triggers. These trigger conditions are merely examples, and other trigger conditions are possible.

One or more target for a movement request message is determined at S610. In an embodiment, an internet-enabled marketplace exists wherein a UE or service provider can search for and/or request a device to perform the role of a movable element that moves to facilitate wireless communication between the base station 508 and the first UE 512. In other words, a UE such as a CPE router may transmit a request over the Internet to identify one or more reflector device 506 that is available to reflect a small wave beam from a nearby base station 512. Such a marketplace may be present in the form of a database that identifies a plurality of available base stations and reflective devices that are organized according to geographic areas, and may be stored on a central server computer that can be accessed through the Internet.

In an embodiment, a first UE 508 that would like to establish a higher level of Internet connectivity may search for candidate movable elements, e.g. one or more device with the ability to change their position, with a potential location impacting line of sight communication between the first UE and at least one base station 512, and which may be willing to change its position to enable small wave communication between the base station and the UE. In one example, a plurality of movable devices and base stations 512 capable of transmitting small beams are present in a geographic area around a location of the first UE 508 are returned from a database search. Such a database may indicate which movable devices would be suitable as reflectors for each base station, which movable devices may be present in possible communication paths between the base station and the UE that can be moved to improve or facilitate communications between the base station and the UE, etc. The marketplace could provide a User Interface (UI) with geographic information such as GPS data projected onto a map that allows a human user to identify optimal combinations of base stations and movable devices that can be used to provide service to a particular UE.

In an embodiment, the movable element reports changes in its position which have an impact on the communication between the first UE 508 and the base station 512, e.g. enabling just-in-time changes to leverage the appearance or disappearance of line of sight communication between the first UE and the wireless base station.

A movement request is transmitted to one or more movable element at S612. The movement request may be a request for the one or more element to move in order to improve wireless communication between a base station 512 and a first UE 508. The base station 512 and first UE 508 may be initially communicating using longer wavelengths which do not require line of sight, and are not high bit rate small wave communications. A communication path may be from the base station 512 to a movable reflector 506, and may be through a path occupied by one or more movable element (e.g. 504 and 502) to the first UE 508.

In an embodiment, the request to the movable may be a request that the third device scan through a range of positions. In some embodiments, the system may prompt a user to change a physical location or orientation of a UE to improve communications.

Upon detecting that the first UE 508 is able to connect to the base station 512 utilizing small waves, one or more entity may record a current position as a preferred position of the movable element, which enables small wave communication between the base station and the first UE. A subsequent request may be conveyed to the movable element that it utilize the recorded preferred position to enable small wave communication between the base station 512 in the first UE 508.

In an embodiment, a request to change the position of the movable element includes one or more of an alert that indicates a relationship between an IOT device and the ability of the first UE 512's device location to connect to a cellular telecommunications network, a request that the movable element automatically perform the physical configuration change, and a request to an end-user to authorize (or perform) the physical configuration change, such as opening a door or clicking to open or close a door.

In an embodiment, a request to change the physical configuration of the movable element device is a request for a future time interval, to align with an anticipated communication of the first UE 508. A request may be made to multiple such devices, e.g. aligning multiple simultaneous changes to achieve communication to the first UE 508. In one example, devices are coordinated such that multiple doorways open simultaneously.

A request to the movable element to change its position may be transmitted using application layer messaging. For example, the movable element and the first UE 508 may communicate using the same IOT application service, and may be certified, approved or manufactured by an entity that controls the IOT application. In some embodiments, the request may be transmitted using air interface messaging. The air interface messaging may be similar to the messaging used for pre-existing device-to-device communications and relay technologies.

For example, the air interface messaging being transmitted over a higher frequency more narrowly focused transmission may essentially instruct any IOT device receiving the message with more than a threshold signal strength, to reconfigure itself to reduce the degree to which it is blocking or occluding a transmission.

A movement request may be transmitted using OSS signaling in a cellular telecommunications network. For example, the movement request may be transmitted over a northbound SA-5 interface, where the base station receives positional index schedules, and other parameters relating to motion capabilities of the movable element. In such an embodiment, cellular infrastructure can generate the movement request, as well as preferences for changes in positional indices.

In an embodiment, messaging may indicate that two different receiving devices appear to both be at the same narrow beam angle. In this case, it is possible that one device is occluding the other device. Furthermore, a round-trip transmission time (RTT) to a second device being larger than an RTT to the first device may indicate that the first device is blocking the second device. In this case, the messaging might request that the first device move to facilitate communication with the second device.

Movable elements that receive a position change request may process that request by determining whether to move in response to the request at S614. In some embodiments, movement of an element, and in particular whether the element responds to a request for movement, may be constrained based on the physical location of the element. When location information for the base station and the first UE 508 are known, a movement request may include a geographic area, where all movable devices within that geographical area respond to the request, and movable devices outside that movable area do not respond to the request.

For example, if the movable element is not a reflector and it is not located near the path the small wave beam takes from the base station 512 to the first UE 508, then the movable element may ignore a movement request sent to movable elements by, for example, broadcasting a movement request signal from the base station. In some embodiments, a limited geographical area is effectively established by transmitting a wireless signal from the base station, which may be the base station that will transmit the small signal beam. In such embodiments, the base station may transmit at a power and/or direction that effectively limits the area in which the request is received.

A movable element may be configured to automatically approve changes to its physical configuration in certain situations, such as in the case of an emergency or high priority call. For example, when an end-user places a 911 call, the communication system may automatically determine that in order to continue with the 911 call, or to enable video telephony with the 911 call, a specific door or doors should be opened. In response, the system automatically may authorize the of opening of such doors, to enable the emergency call.

When multiple autonomously movable doors are present in a building, knowledge of and the ability to change physical configuration of those doors may be useful to emergency personnel responding to an emergency situation in the building.

After having established a relationship between the status of the movable element, such as whether a door 502 is open or closed, and the ability of the base station to communicate with a first UE 508, the request to change position may be transmitted to the movable element. In response to the request, the movable element changes its position at S616 to facilitate communication between the base station 512 and the first UE 508. The position change may be executed by engaging a motor 406 that controls the movable element's position.

Upon detecting that movable element has changed its position or status, e.g. door 502 open versus closed, a system according to an embodiment may automatically update a wireless performance map based upon the new position. In addition, the system may change other aspects of a wireless environment based on the change, such as causing an additional wireless base station to turn on or off, in order to compensate for the resulting reduction in coverage change.

The UE 508 may automatically initiate specific application behaviors, such as initiating file transfers, upon detecting that a movable device performed a specific physical configuration change at S618. For example, the UE may automatically update wireless path communication costs within a network knowledge database, such as that described by the Internet Engineering Task Force (IETF) Request for Comment (RFC) 7285, which is incorporated herein by reference, upon detecting that a second device has performed a specific physical configuration change.

The cost between a particular source node and destination node may be conveyed according to protocols described by the IETF. This information can also be conveyed in other ways, including leveraging TCP header enrichment, e.g. as a part of IETF rules. A source identifier, a destination identifier, and a calendar of time intervals are inputs which can be used to determine a cost value.

In an embodiment, a cost server, which may be a server hosted by an operator or IOT provider, and possibly following the IETF standard, can receive IOT positional index information, and use the index information in combination with the path RF cost impacts implied by the various positional index values, in order to provide RF cost values based on the IOT positional indices. A positional index exchange update may occur with an IOT service database, to trigger appropriate updates and adaptations.

An IOT service database may indicate that a wireless path communication cost can be changed by one or more movable element that is accessible through IOT communications. In other words, the database may indicate which existing and/or possible wireless paths can be affected by specific movable elements.

In addition, or as an alternative to such database information, a movable element may advertise a willingness to perform specific physical configuration changes to facilitate small wave communications. Such an advertisement may be transmitted to devices within the vicinity of a UE to which small wave transmissions are requested, e.g. first UE 508. In a specific embodiment, a UE transmits a request to receive small wave communications from a nearby base station 502, and IOT enabled movable devices that are within a nearby geographic area and are available to facilitate communications transmit a response that they are available. Such a response may include information relevant to the communications, such as the type of device, its location, applicable constraints that may limit the devices ability to move at certain times or in certain situations, and other data identifying or characterizing the device and its ability to facilitate communications.

An example embodiment will now be explained using some of the features discussed above and FIG. 5. In the example, when a reflector 506 movable element is installed, it engages in path discovery with the base station 512. Path discovery is performed late at night during a time of slow traffic to minimize service interruptions. In path discovery, base station 512 transmits a beam index until the reflector 506 detects a signal, and informs the base station, at which point the position of the reflector and/or beam is stored.

The reflector, as well as other movable elements (e.g. door 502 and window covering 504) advertise their services to local UEs and base stations, either wirelessly to a local area or through an Internet service such as an IOT service. A first UE 508 is installed at a customer's premises, and the UE 508 transmits a request to receive small wave communications from a nearby base station 512. The service request may be transmitted wirelessly to nearby devices, or through the Internet.

Base station 512 receives the service request, and communicates with the reflector 506 to establish a small wave connection with the first UE 508. To establish this connection, the reflector 506 may change position between predetermined increments using a stepper motor, and pause at each position to determine its effect on communications to the first UE 508. When a position is found that establishes a small wave connection, that position may refined to maximize signal strength, and stored in a memory of the reflector 506, the base station 512, or a remote server computer.

In addition, IOT enabled window covering 504 and door 502 change positions, which affects the ability of the first UE 508 to receive small wave communications. Information regarding the positions and their effects on the communication channel are stored at a central computer that coordinates communication between the various entities.

This simplified example is provided to promote understanding of some of the concepts of this disclosure, and is not meant to be limiting or exclusive. For example, in some embodiments, base station 512 stores position information and coordinates activity between the associated devices, removing the need for a central computer.

Embodiments of the present disclosure represent improvements to delivering broadband communications to satisfy the ever-growing demand for wireless content. One relatively simple solution is to simply deploy an ever-increasing number of base stations that can beam small wave transmissions directly into structures in LOS conditions. However, the expense of such an endeavor is prohibitive. In addition, there are many situations where it is simply not practical to deploy base stations in the physical locations required for LOS conditions. In some circumstances, a physical location that creates a LOS condition is only viable for a single structure, so an entire base station would be required just to provide service to a single structure.

Approaches envisioned by the present disclosure are much more efficient. A single base station can provide multiple small wave beams, so the amount of base stations required to implement solutions according to the present disclosure are more efficient that installing base stations to create direct LOS conditions. While some movable reflector elements may be installed along with those base stations, the capital and operating costs of a movable reflector are much lower than those of a base station.

Using existing, non-movable static elements as reflectors has a number of disadvantages. While certain cellular installations have been able to use large structures such as exposed rock faces and buildings to reflect signals into, e.g., narrow valleys or downtown corridors, such structures are not generally appropriate for accurately reflecting small waves. Because portions of the small wave spectrum have very small wavelengths, they are sensitive to relatively minor surface imperfections, which makes it very difficult to reliably reflect off organic structures, or structures with relatively rough surfaces, such as wood and brick. Natural surfaces tend to change over time, potentially requiring regular adjustments and signal loss.

Narrow-beam reflection is more difficult to engineer owing to the need to find an object that can provide the necessary angle of incidence to propagate as desired. Studies have shown that building surfaces are quite rough at millimeter wavelengths and the reflections are too dispersive to support high data rates.

Another benefit of using controlled, active reflectors is that they may be owned and/or controlled by an entity with an interest in providing broadband communications. In contrast, relying on passive structures that are owned and controlled by parties that may have no interest in providing broadband communication presents a substantial risk that such structures would be altered by the owner in a way that affects the broadband communications.

What is claimed is:

1. A method for providing broadband communications in a wireless communications network, the method comprising:
transmitting a movement request to a movable element to change a position,
wherein the movable element is in a beam path for an RF communications beam of more than 6 GHz between a first user equipment (UE) and a base station.

2. The method of claim 1, wherein the RF communications beam is transmitted from the base station to the first UE, and
wherein the movable element is a reflector that reflects the RF communications beam from the base station to the first UE.

3. The method of claim 2, wherein, before transmitting the request, the base station transmits RF beams in a plurality of directions to identify a beam direction that is successfully received by the reflector.

4. The method of claim 3, wherein the plurality of directions is a set of directions that are determined using a location of the base station and a location of the reflector.

5. The method of claim 2, wherein the reflector has a convex outer surface comprising a plurality of flat elements arranged in a convex shape.

6. The method of claim 2, wherein, in response to the request, the reflector moves from a first position from which it reflects the RF communications beam to the first UE to a second position from which it reflects the RF communications beam to a second UE.

7. The method of claim 1, wherein the first UE is customer premises equipment (CPE) that is installed at a static location of a building structure.

8. The method of claim 7, wherein the movement request is triggered by an installation routine that is performed when the first UE is installed at the static location.

9. The method of claim 1, wherein the movable element is an Internet-of-Things (IOT) enabled device that blocks the beam path for the RF communications beam, and the movable element moves to unblock the beam path in response to the movement request.

10. The method of claim 1, wherein the movable element is a reflector with a convex outer surface that has established a connection to receive the RF communications beam from the base station,
wherein the base station is a small cell base station that provides broadband communications over at least one RF communication channel of 25 GHz to 100 GHz, and
wherein, in response to the movement request, the reflector moves from a first position to a second position in order to reflect the RF communications beam to the first UE.

11. A wireless communication system comprising:
a base station;
at least one movable device;
one or more processor; and
one or more non-transitory computer readable medium which, when executed by the one or more processor, perform the following operations:
transmitting a movement request to a movable element to change a position,
wherein the movable element is in a beam path for an RF communications beam of more than 6 GHz between a first user equipment (UE) and a base station.

12. The system of claim 11, wherein the RF communications beam is transmitted from the base station to the first UE, and
wherein the movable element is a reflector that reflects the RF communications beam from the base station to the first UE.

13. The system of claim 12, wherein, before transmitting the request, the base station transmits RF beams in a plurality of directions to identify a beam direction that is successfully received by the reflector.

14. The system of claim 13, wherein the plurality of directions is a set of directions that are determined using a location of the base station and a location of the reflector.

15. The system of claim 12, wherein the reflector has a convex outer surface with at least one RF-transparent portion by which the reflector detects the presence of the RF communications beam.

16. The system of claim 12, wherein in response to the request, the reflector moves from a first position from which it reflects the RF communications beam to the first UE to a second position from which it reflects the RF communications beam to a second UE.

17. The system of claim 11, wherein the first UE is customer premises equipment (CPE) that is installed at a static location of a building structure.

18. The system of claim 11, wherein the movement request is triggered by an installation routine that is performed when the first UE is installed at the static location.

19. The system of claim 11, wherein the movable element is an Internet-of-Things (IOT) enabled device that blocks the beam path for the RF communications beam, and the movable element moves to unblock the beam path in response to the movement request.

20. The system of claim 11, wherein the movable element is a reflector with a convex outer surface that has established a connection to receive the RF communications beam from the base station,
wherein the base station is a small cell base station that provides broadband communications over at least one RF communication channel of 25 GHz to 100 GHz, and
wherein, in response to the movement request, the reflector moves from a first position to a second position in order to reflect the RF communications beam to the first UE.
